(19) United States
(12) Patent Application Publication
(10) Pub. No.: US 2010/0230496 A1
(43) Pub. Date: Sep. 16, 2010

(54) ELECTRONIC CARD AND METHOD FOR FABRICATING THEREOF

(75) Inventor: Young Soo Kim, Gyeonggi-do (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Softpixel, Inc., Gyeonggi-do (KR)

(21) Appl. No.: 11/993,997

(22) PCT Filed: Sep. 13, 2007
(86) PCT No.: PCT/KR2007/004422

§ 371 Date: Dec. 27, 2007

(30) Foreign Application Priority Data
Sep. 22, 2006 (KR) 10-2006-0092348
May 2, 2007 (KR) 10-2007-0042560

(51) Int. Cl. G06K 19/077; B32B 37/24

(52) U.S. Cl. 235/488; 156/307.1

(57) ABSTRACT

An object of the present invention is to provide an electronic card equipped with a display by a batch processing, adopting a dam around the edge of the card and a curable resin, and the method for fabricating thereof. Another object of the present invention is to provide an electronic card including a static electricity blocking film and the method for fabricating thereof. An electronic card according to the present invention comprises a dam formed around the edge of a first printing film with a certain width and height; a flexible PCB and an IC chip formed on said first printing film; a display to show information inputted or outputted through said IC chip; and a curable resin to be infused onto said first printing film.

### TECHNICAL FIELD

The present invention relates to an electronic card equiped with a display, more particularly, which is fabricated by forming a dam around the edge of the card, and installing therein an IC chip, an RFID module, a battery, and a display, and infusing curable resin thereon.

### BACKGROUND ART

One of the most common kind of electronic cards is a generally used contact-type IC card, which, after making space to mount a certain smart IC chip therein on the surface of a plastic card as the same material with used in a credit card, attaches a microprocessor (MCU, 1 k·64 kbytes) with its own arithmetic function, an operating system (COS), and an IC chip with EEPROM installed as a safe storage area. An IC card is activated by its contact point being contacted with that of an IFD (Interface Device) when the IC card is inserted into the IFD. Even though such a card would be electronically shocked or damaged due to frequent contacts of the contact point, it is generally used in the fields which require high level of security and need to execute a specific encryption algorithm in a card.

Another type of electronic card is a non-contact-type RF card of which popularization is resulted from the development of an RFID module. An RF card has a microprocessor and a memory essential to information processing in common with an IC card, but it communicates with an IFD by means of a radio frequency signal (electromagnetic induction method), is supplied with power through electromagnetic coupling of the antenna installed in the card, and does not need a physical contact with a card reader.

Besides, as a hybrid card and a combi card can be applied with contact-type and non-contact-type together, they come in to the spotlight and the use of those cards is increasing.

A hybrid card is characterized by not sharing internal resources since a contact-type card and a non-contact-type card are independent of each other in one electronic card. Each card uses their own memory, and can adopt more than two separated operating systems. The hybrid card has advantages in that it can be permanently used because of no damage to chip-on-board(COB), memorize a large amount of data, and be applied to various fields as a multipurpose use with one card.

A combi card is a chemically combined type of card in which a contact-type and a noncontact-type card share sharable resources with each other. The card has advantages in that it can achieve a combination effect of heterogeneous applications by sharing internal resources, memorize a large amount of data, be hardly forged or falsified due to its function of high security, and be applied to various fields as a multipurpose use with one card.

Recently such electronic cards come to have a power supply device and a display equipped additionally, thereby making it possible to refer contents stored in the cards and control of access or pass with a RFID module generating a password using a micro controller unit (MCU) to display.

These electronic cards equipped with a display is completed with the steps of fixing an IC chip and a display onto a plastic board and hotpressing thereon several plastic boards with space formed to install the IC chip and the display.

Conventional card fabricating method of perforating plastic boards and compressing them with heat applied, however, has drawbacks, when fabricating cards with circuit module of various size and thickness, in that the processing steps are increased and precise assembly is hardly achievable. The difficulty in precise assembly is a cause of failure to meet flexibility and size requirement of international standardization. In addition, the heat of high temperature of more than 150° C. applied in the processing step of hotpressing causes to damage the display installed in the card.

Besides, another problem arising from the use of IC chip included cards being popularized is damages by static electricity which is generated when contacting the user and a card reader. The static electricity damages the circuit and the memory included in the IC chip, resulting in damaging the electronic card to lose its functionality permanently.

### DISCLOSURE OF INVENTION

### Technical Problem

The present invention has been made in an effort to solve the above problems in the prior art, and an object of the present invention is to provide an electronic card equipped with a display by a batch processing, adopting a dam around the edge of the card and a curable resin, and the method for fabricating thereof.

Another object of the present invention is to provide an electronic card including a static electricity blocking film and the method for fabricating thereof.

### Technical Solution

An electronic card according to the present invention comprises a dam formed around the edge of a first printing film with a certain width and height; a flexible PCB and an IC chip formed on said first printing film; a display to show information inputted or outputted through said IC chip; and a curable resin to be infused onto said first printing film.

A method for fabricating an electronic card according to the present invention comprises a first step of coating a curable resin on a first printing film and attaching a dam with a certain width and height thereto; a second step of installing a flexible PCB, an RFID module, and a display on said first printing film; a third step of infusing a curable resin onto said first printing film; and a fourth step of setting a second printing film on said dam and curing said curable resin.

### Advantageous Effects

An electronic card in accordance with the present invention can be fabricated by a batch processing without damaging the installed display with heat, and the card including the display has a prominent effect in durability against bending.

In addition, the present invention has another effect in that its components such as an IC chip, an MCU, a display, and the like are protected from static electricity.

### BRIEF DESCRIPTION OF THE DRAWINGS

FIG. 1 is an exploded perspective view of an electronic card in accordance with an embodiment of the present invention;

FIGS. 2 to 9 are flow diagrams illustrating the process of fabricating an electronic card in accordance with the present invention; and

FIG. 10 is an exploded perspective view of an electronic card in accordance with another embodiment of the present invention.

### DESCRIPTION ON MAIN REFERENCE NUMERALS

110: first printing film 120: curable resin

130: dam 140: battery

150: RFID module 160: display

170: flexible PCB 180: security switch

181: MCU 190: IC chip

200: second printing film 210: alignment pin

220: arrangement plate 240: pressure plate

260: roller 310: static electricity blocking film

### MODE FOR THE INVENTION

Hereinafter, the preferred embodiments of the present invention will be described in detail with reference to the accompanying drawings. The terms and the words used in the specification and the claims should not be limitedly construed with ordinary or lexical meaning. Rather, they should be construed with the meanings and the conceptions according to the idea of the present invention, abiding by the principle that an inventor can properly define the conception of terms so as to describe his or her own invention with the best manner.

While the present invention has been described with reference to particular illustrative embodiments, it is not to be restricted by the embodiments but only by the appended claims. It is to be appreciated that those skilled in the art can change or modify the embodiments without departing from the scope and spirit of the present invention.

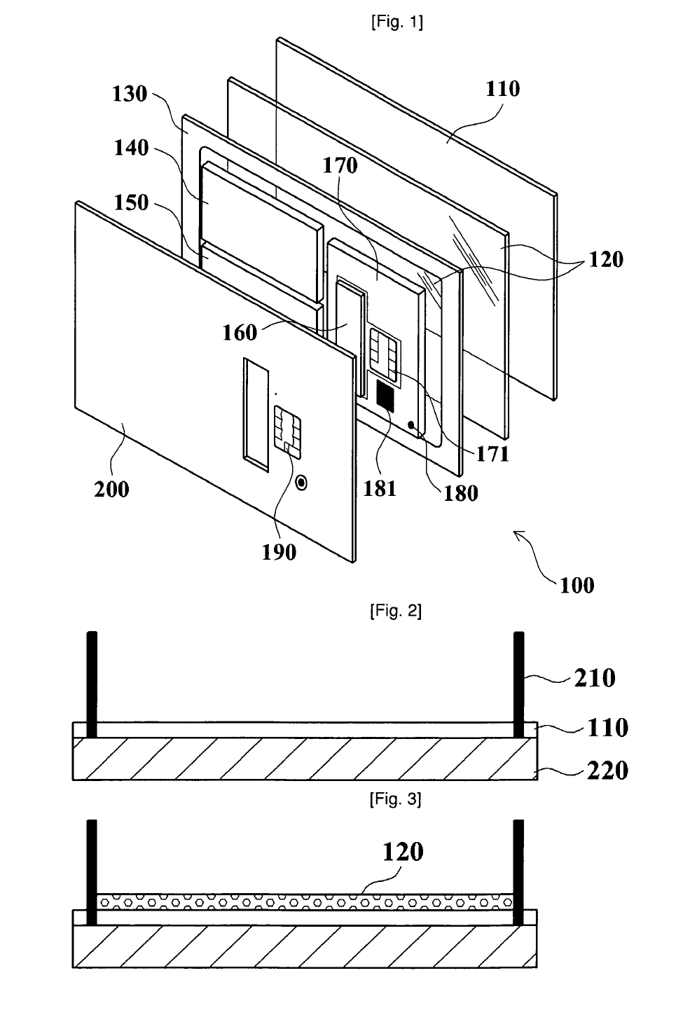

FIG. 1 is an exploded perspective view of an electronic card 100 in accordance with an embodiment of the present invention.

A first printing film 110 coated with a curable resin 120 has a dam 130 formed with a certain width and height around its edge.

The curable resin 120 in accordance with the present invention is a heat or UV(Ultraviolet) curable resin. The heat curable resin may be selected from the group consisting of a polyurethane, a phenolic resin, a melamine resin, and an alkyd resin.

The height of the dam 130 in accordance with the present invention is formed less than 0.84 mm, which is appropriate to an international standard for the thickness of a card. The material for the dam 130 is preferably non-deformable under heat applied for curing the heat curable resin.

A battery 140, an RFID module 150, a display 160, and a flexible PCB 170 are installed within the inner space of the dam 130 attached onto the first printing film 110. The RFID module 150 serves to transfer/receive information in the card to/from a non-contact-type reader, and is used in an employee identification in a field of high security, for the purpose of control of access or pass, in a transportation card (prepaid or chargable), or in a parking lot. The battery supplies power necessary to operation of an MCU 181 connected with flexible PCB 170 and the display 160.

The battery 140 in accordance with the present invention makes use of a photoelectric cell, able to semi-permanently provide power necessary to operation of other components including the display 160.

According to an embodiment of the present invention, the flexible PCB 170 is equipped thereon with a security switch 180 and an MCU (micro controller unit) 181 with a security program installed. When one presses the security switch 180, an OTP (one time password) necessary for access or pass to an security area is shown on the display.

According to another embodiment of the present invention, the flexible PCB 170 is connected with a fingerprint reader (not shown), thereby applying a security system adopting fingerprint authentication as well, where a password is given when the fingerprint of a user agrees with the user's fingerprint information stored in an IC chip 190.

The display in accordance with the present invention is a flexible display which is not damaged by bending the electronic card 100. It is preferable to use the micropixel LCD disclosed in the PCT application no. PCT/KR2005/004108 by the present applicant.

After the battery 140, the RFID module 150, the display 160 and the flexible PCB 170 are installed on the first printing film 110, the body of the electronic card is formed by infusing a curable resin 120 over the surface of the first printing film 110 except the area where the battery 140, the RFID module 150, the display 160 and the flexible PCB 170 are installed. The amount of the curable resin to be infused is preferably measured up to the height of the dam 130.

After the curable resin 120 is infused, a second printing film 200 with the IC chip 190 attached is attached thereto and the curing is carried out by heat treatment or UV irradiation. When a heat curable resin is used, the curing temperature is about 55° C., at which damage to the flexible LCD including a heat-sensitive substrate is prevented.

The IC chip 190 in accordance with the present invention is contacted with an electrode 171 formed on the flexible PCB 170 which is attached onto the first printing film 110, and used for the purpose of a credit card, a public phone card, a membership card, an electronic cash, etc.

The IC chip 190 and the RFID module 150 are connected with the flexible PCB 170, and shown on the display 160 is the information which is inputted or outputted in the process of being activated by a contact-type or non-contact-type reader.

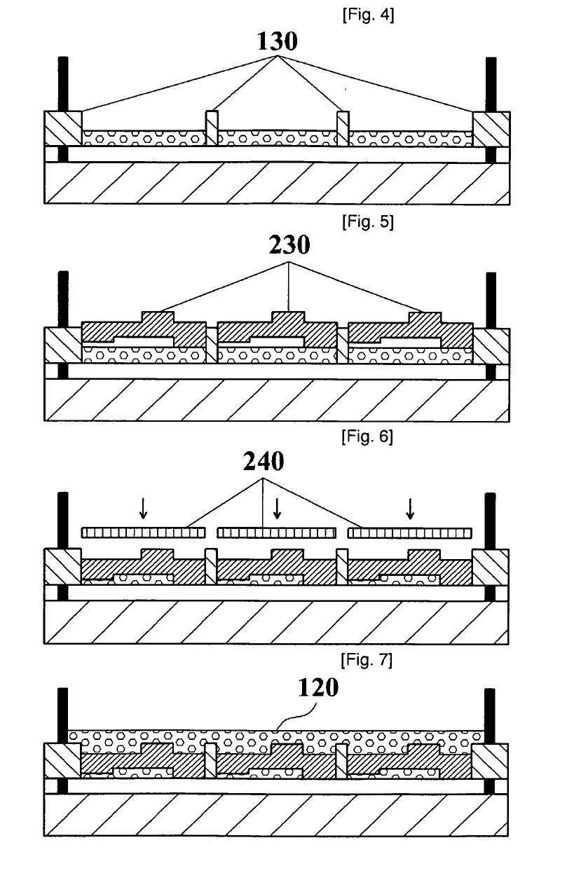

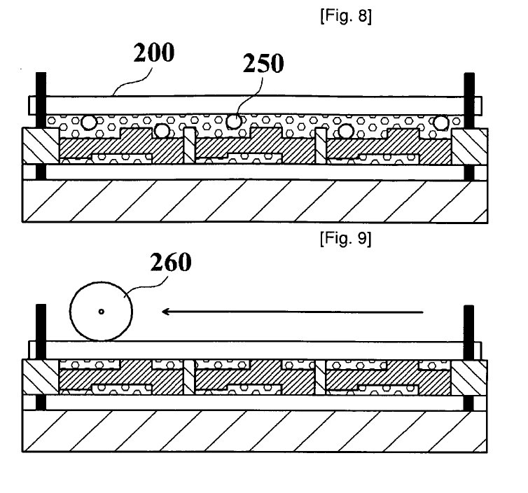

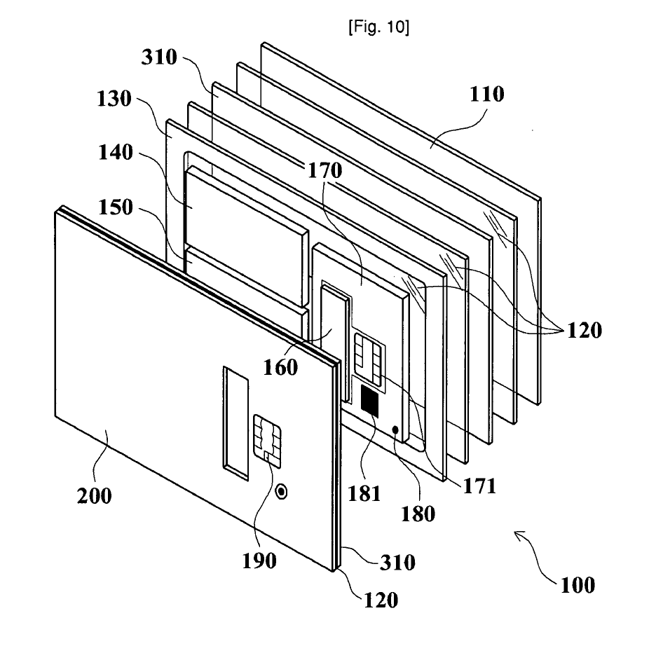

FIGS. 2 to 9 are flow diagrams illustrating the process of fabricating an electronic card in accordance with the present invention.

First, a first printing film 110 is fixed on an arrangement plate 220 formed with an alignment pin(s) 210. The first printing film 110 in accordance with the present invention may be a bendable and insulating PET (polyethylene terephthalate) substrate with a thickness of tens of micrometers.

After the first printing film 110 is fixed on the arrangement plate 220, a curable resin 120 is coated thereon with a certain thickness. At this time, it is necessary to control the amount of the curable resin 120 so that the curable resin 120 may not overflow a dam 130, which will be described in the following process.

After the curable resin 120 is coated, a plurality of films with the dam 130 patterned are attached to the first printing film 110, components 230 including a battery 140, an RFID module 150, a display 160, a flexible PCB 170, and an MCU 181 are set on the space formed within the dam 130.

In order to improve the adhesive force of the battery 140, the RFID module 150, the display 160, the flexible PCB 170, and the MCU 181 with the curable resin 120, a pressure plate 240 is used with a certain downward pressure to press and sink the battery 140, the RFID module 150, the display 160, the flexible PCB 170, and the MCU 181 into the inner space of the dam 130.

Next, more curable resin 120 is dropped over the entire surface of the battery 140, the RFID module 150, the display 160, the flexible PCB 170, and the dam 130, and planarization thereof is performed.

According to the present invention, in case that an IC chip (not shown) is mounted in the following process, the curable resin 120 should be dropped except the area where the IC chip contacts with the flexible PCB, and planarization is performed partly.

An second printing film 200 is set on the entire surface of the planarized curable resin 120, taking advantage of the alignment pin(s) 210 formed on the arrangement plate 220.

According to the present invention, the second printing film 200 is preferably made from a bendable PET, and has an IC chip (not shown) mounted thereon after perforating thereof beforehand. In order for the IC chip to be mounted on the exact place of the flexible PCB, alignment hole(s) are formed in the second printing film 200 corresponding the alignment pin(s) 210 formed on the arrangement plate 220.

In the process of setting the second printing film 200, bubbles 250 are created among the curable resin 120. In order to eliminate the bubbles 250, a roller 260 is made to roll with a certain pressure from one end to the other end on the second printing film 200. Then, overcharged curable resin 120 is eliminated as well as the bubbles 250.

After pressing with the roller 260 is completed, the curing of the curable resin 120 is performed with UV irradiation or heat treatment at a certain temperature. After curing is completed, a card is finished by cutting.

FIG. 10 is an exploded perspective view of an electronic card in accordance with another embodiment of the present invention.

A static electricity blocking film 310 is attached on a curable resin 120 coated on the entire surface of a first printing film 110.

The material of the static electricity blocking film 310 in accordance with the present invention is preferably selected from a thin metal film made from anyone of gold, silver, aluminum and copper, and a conductive resin made from organic materials.

The curable resin 120 is coated on the entire surface of the static electricity blocking film 310, and a dam 130 is formed around the edge of the first printing film 110 with a certain width and height.

A battery 140, an RFID module 150, a display 160, and a flexible PCB 170 are installed within the inner space of the dam 130 attached onto the first printing film 110.

The battery 140 in accordance with the present invention makes use of a photoelectric cell, able to semi-permanently provide power necessary to operation of other components including the display 160.

According to an embodiment of the present invention, the flexible PCB 170 is equipped thereon with a security switch 180 and an MCU (micro controller unit) 181 with a security program installed.

When one presses the security switch 180, an OTP (one time password) necessary for access or pass to an security area is shown on the display.

According to another embodiment of the present invention, the flexible PCB 170 is connected with a fingerprint reader (not shown), thereby applying a security system adopting fingerprint authentication as well, where a password is given when the fingerprint of a user agrees with the user's fingerprint information stored in an IC chip 190, and the user can come in and out of a security area with the password.

After the battery 140, the RFID module 150, the display 160 and the flexible PCB 170 are installed on the first printing film 110, the body of the electronic card is formed by infusing a curable resin 120 over the surface of the first printing film 110 except the area where the battery 140, the RFID module 150, the display 160 and the flexible PCB 170 are installed. The amount of the curable resin to be infused is preferably measured up to the height of the dam 130.

After the curable resin 120 is infused, the steps of attaching another static electricity blocking film 310 thereto, coating more curable resin 120 thereto, and attaching a second printing film 200 with the IC chip 190 thereto are sequentially carried out. Thereafter follows the curing by heat treatment or UV irradiation. When a heat curable resin is used, the curing temperature is about 55° C., at which damage to the flexible LCD including a heat-sensitive substrate is prevented.

The IC chip 190 in accordance with the present invention is contacted with an electrode 171 formed on the flexible PCB 170 which is attached onto the first printing film 110, and used for the purpose of a credit card, a public phone card, a membership card, an electronic cash, etc. The IC chip 190 and the RFID module 150 are connected with the flexible PCB 170, and shown on the display 160 is the information which is inputted or outputted in the process of being activated by a contact-type or non-contact-type reader.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. An electronic card, comprising:
a dam formed around the edge of a first printing film with a certain width and height;
a flexible PCB and an IC chip formed on said first printing film;
a display to show information inputted or outputted through said IC chip; and
a curable resin to be infused onto said first printing film.

2. The electronic card of claim 1, wherein said display is a flexible display.

3. The electronic card of claim 2, wherein said flexible display is a micropixel LCD.

4. The electronic card of claim 1, further comprising an MCU (micro controller unit) to generate a password, and a security switch to show said password on said display.

5. The electronic card of claim 1, wherein said flexible PCB is connected with an RFID module to communicate with a non-contact-type reader.

6. The electronic card of claim 5, wherein said flexible PCB is connected with a fingerprint recognition device to identify a user.

7. The electronic card of claim 1, wherein said first printing film has a static electricity blocking film attached.

8. The electronic card of claim 7, wherein said curable resin is attached thereon with a second printing film equipped with a static electricity blocking film.

9. The electronic card of claim 8, wherein said static electricity blocking film is formed of a material selected from the group consisting of gold, silver, aluminum, copper, and a conductive resin of an organic material.

10. A method for fabricating an electronic card, comprising:
a first step of coating a curable resin on a first printing film and attaching a dam with a certain width and height thereto;
a second step of installing a flexible PCB, an RFID module, and a display on said first printing film;
a third step of infusing a curable resin onto said first printing film; and
a fourth step of setting a second printing film on said dam and curing said curable resin.

11. The method for fabricating an electronic card of claim 10, further comprising, after the second step, a step of pressing downwards said flexible PCB, said RFID module, and said display using a pressure plate thereon.

12. The method for fabricating an electronic card of claim 11, wherein the fourth step further comprises, after setting said second printing film on said dam, a step of pressing with a roller rolling from one end to the other on said second printing film.

13. The method for fabricating an electronic card of claim 10, wherein the first step further comprises a step of attaching a static electricity blocking film on the entire surface of said first printing film using said curable resin.
